(19) United States
(12) Patent Application Publication
(10) Pub. No.: US 2023/0103839 A1
(43) Pub. Date: Apr. 6, 2023

(54) SYSTEMS AND METHODS FOR ANALYZING AND PRESENTING A VEHICLE INCIDENT

(71) Applicant: Quantiv Risk Inc., New York, NY (US)

(72) Inventors: Mike NELSON, New York, NY (US); Eugene LEE, New York, NY (US)

(73) Assignee: Quantiv Risk Inc., New York, NY (US)

(21) Appl. No.: 17/957,027

(22) Filed: Sep. 30, 2022

Related U.S. Application Data
(60) Provisional application No. 63/251,560, filed on Oct. 1, 2021.

(51) Int. Cl. H04L 9/40; G07C 5/00

(52) U.S. Cl. CPC H04L 63/08; G07C 5/008

(57) ABSTRACT

This disclosure describes systems and methods related to analyzing a vehicle incident. A method for analyzing a vehicle incident, comprising: sending an authentication request to a device associated with a vehicle data storage system, receiving from the device, an authentication response, sending to the vehicle data storage server, a request for vehicle data of a vehicle, receiving based on the authentication response and the request for vehicle data, the vehicle data, determining a time associated with a vehicle incident associated with the vehicle, identifying, based on the time, video data of the vehicle data, the video data associated with a camera of the vehicle, identifying based on the time and the video data, first data of the vehicle data, the first data comprising vehicle event data recorder data of the vehicle, and generating a report indicative of a relationship between the video data and the first data at the time.

### TECHNICAL FIELD

This application claims priority to U.S. Provisional Application No. 63/251,560, filed on Oct. 1, 2021, the entire contents of which are incorporated herein by reference. This disclosure generally relates to systems and methods for analyzing a vehicle incident and, more particularly, to collecting, assessing, and presenting information pertaining to a vehicle incident.

### BACKGROUND

The determination of facts surrounding a vehicle accident can be complicated and subjective. In many instances, vehicle operators are interviewed at the scene of the vehicle accident, but the vehicle operators' memories may not be accurate due to a variety of reasons; for example, trauma induced by the vehicle accident, a different perception and/or memory, and external incentives for providing an inaccurate retelling of the vehicle accident. In other instances, interviews can be conducted after a period of time following the vehicle accident, which may result in an inaccurate retelling of facts surrounding the vehicle accident due to memory loss.

As a result, various stakeholders, such as insurance companies, vehicle owners, lien holders, and courts, have to rely on potentially inaccurate accounts of a vehicle accident when determining a cause of the vehicle accident. It is thus necessary for a precise and objective account of a vehicle accident to be collected and recorded, and for the precise and objective account to be transmitted to the various stakeholders as needed. Such a solution provides the various stakeholders with the ability to objectively and efficiently analyze the vehicle accident.

### BRIEF DESCRIPTION OF THE DRAWINGS

FIG. 1 depicts an illustrative architecture in which structures and systems for providing one or more techniques (e.g., methods), in accordance with one or more example embodiments of the present disclosure.

FIG. 2 depicts an illustrative diagram of a process for analyzing a vehicle accident, in accordance with one or more example embodiments of the present disclosure.

FIG. 3 depicts a flow diagram of an illustrative process for analyzing a vehicle accident, in accordance with one or more example embodiments of the present disclosure.

FIGS. 4-6 depict example dashboard interfaces, in accordance with one or more example embodiments of the present disclosure.

FIG. 7 illustrates a block diagram of an example machine or system upon which any of one or more techniques (e.g., methods) may be performed, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Example embodiments of the present disclosure relate to systems and methods for analyzing a vehicle incident.

In one or more embodiments, a method for analyzing a vehicle incident may be provided. Vehicles may communicate with respective services (e.g., any vehicle manufacturer/make may have a system that collects data from a vehicle). After a vehicle incident, such as a vehicle accident, a requestor may request the vehicle data from one or more vehicle data storage systems (e.g., for the different manufacturers/makes of vehicles that are involved in the incident) for certain vehicle data. To ensure that the vehicle data is provided to an authorized party, the requesting service (e.g., a vehicle data analysis system) may authenticate to the one or more vehicle data storage systems prior to the one or more vehicle data storage systems providing the requested vehicle data to the requestor. The authentication may verify the identity of the requestor. Once the requestor's identity has been verified, the requested vehicle data may then be sent to the requestor. The requestor may then analyze the vehicle data in order to create an objective account of the vehicle accident to enable a stakeholder to apportion fault associated with the vehicle accident based at least in part on the vehicle data and rules adopted by the requestor. In this manner, rather than an insurance company, claims adjuster, or law enforcement agent having to interview the parties involved in an accident, the requesting system may provide an objective account of the accident to a stakeholder to objectively determine fault and liability for the accident. Accordingly, insurance claim processes and law enforcement analysis may be improved by analyzing vehicle data using an automated system of the requestor.

In one or more embodiments, the requesting system may receive the vehicle data in a format that is inconvenient for a user such as law enforcement or an insurance company. For example, the vehicle data may be provided in a hexadecimal format, which the requesting system may convert to another more convenient format that a user may understand when analyzing a vehicle incident. The vehicle data may include thousands of data points for just a few seconds of time before and during a vehicle incident. Unlike event data recorders, which capture small bits of data over a 5 second interval and only in the event of significant accident, vehicle performance data is generated by an automobile as part of its normal operation. Car manufacturers capture vehicle performance data when an accident occurs. Vehicle cameras may provide video data, including video clips of an accident. Other vehicle sensor data may be provided. The requesting system may correlate the time when the video data shows an incident to the time of other data points provided by the vehicles. For example, a vehicle's speed, direction, lane, steering wheel angle, driver assist systems, and the like may indicate whether a user provided inputs to a vehicle, whether a vehicle was driving the speed limit, whether a driver properly or improperly operated the vehicle, and the like. Using the video and vehicle data from multiple vehicles, the requesting system may determine context that supplements the event history of the accident, and may use the context to generate reports (e.g., accident reports, insurance claims, etc.) and determine liability.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

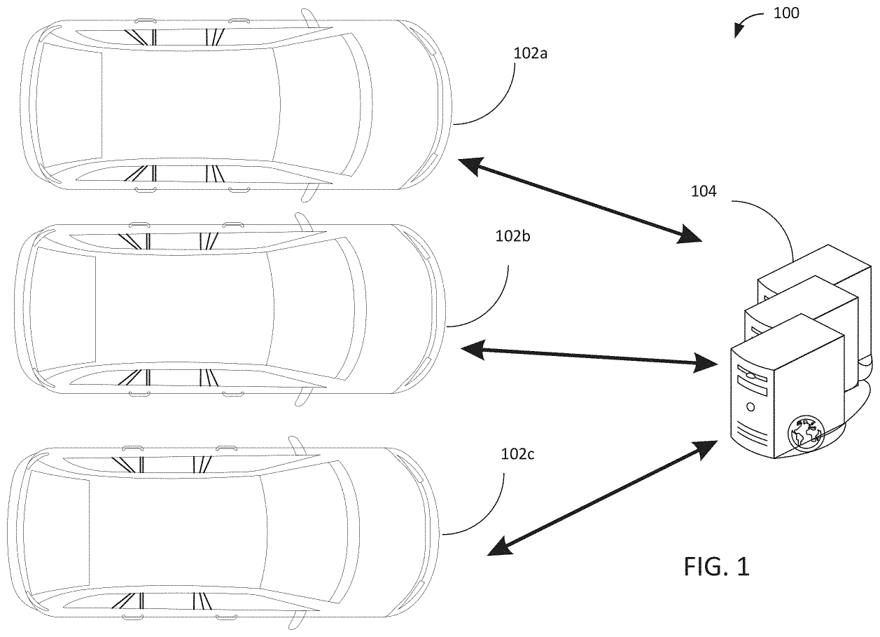

FIG. 1 is an illustrative architecture 100 in which structures and systems for providing one or more techniques (e.g., methods) are depicted.

Referring to FIG. 1, in one or more embodiments, A first vehicle 102a, a second vehicle 102b, and/or a third vehicle 102c may be operated on a road. In other embodiments, more or less vehicles may be operated on the road. Each of the vehicles 102 may be connected to vehicle data storage servers 104 over a WiFi or cellular network, for example. Specifically, each vehicle 102 may be capable of sending data collected at each vehicle 102 to the vehicle data storage servers 104. In one or more embodiments, the vehicle data storage servers 104 may be operated by a vehicle manufacturer, so a particular vehicle make may send its data to a respective manufacturer of the vehicle make.

In one or more embodiments, all data collected at each vehicle 102 may be automatically sent to the vehicle data storage servers 104. In other embodiments, a subset of the data collected at each vehicle 102 may be sent to the vehicle data storage servers 104 upon a request by the vehicle manufacturer in the event of a vehicle accident. In such embodiments, the subset of the data collected at each vehicle that is being sent may be limited to a particular vehicle identifier and/or a particular time period.

In one or more embodiments, the data that is being sent may only include data that is not personally identifiable in order to address privacy concerns. In other embodiments, the data that is being sent may include any type of data that is collected by each vehicle 102. The data collected by each vehicle 102 may include: a vehicle identification number, a date and/or time at which the data 102 is being recorded, a version of firmware in use at the vehicle, any alerts being displayed at the vehicle, an ambient temperature of the vehicle, a state of the contactor of the vehicle, any crashes and/or collisions detected at the vehicle, whether the vehicle driver's seat belt was buckled, whether each vehicle passenger's seat belt was buckled, a status of each of the vehicle's airbags, a status of the vehicle's traction control system, a status of the vehicle's steering and suspension (SAS) system, a torque of a torsion bar of the vehicle, a torque of the vehicle's motor, a revolutions per minute (RPM) measurement of the vehicle's motor, the vehicle's odometer reading, the vehicle's brake activity, a status of the vehicle's stability control system, a longitudinal and/or lateral acceleration of the vehicle, a position of the vehicle's gas pedal, a status of whether the vehicle is engaged in an automatic lane change, a status of whether the vehicle's cruise control system is engaged, a status of whether the vehicle's autopilot system is engaged, a speed of the vehicle, a status of whether a crash detection system of the vehicle is engaged, a determination of the severity of a crash if the vehicle is involved in a collision, a status of whether the vehicle's automatic parking system is engaged, a pressure of each of the vehicle's wheels, an angle of a steering wheel, a detected lane in which the vehicle is traveling in, a direction of travel of the vehicle, video feed from various cameras at the vehicle, and/or a presence of a driver in the vehicle. In one or more embodiments, the data 102 may further include data associated with uninsured property damage (UPD), data associated with a vehicle's event data recorder (EDR), and other sensor data, such as mapping data and telematics data. This list is intended to be non-exhaustive and may further include other types of data associated with the vehicle.

In some embodiments, the data 102 may include: VIN, DATE (UTC), Firmware Version, Alert, PT_GTW_ambientTemperature, PT_BMS_contactorState, CH_RCM_frontCrash, CH_RCM_ndFrontCollision, CH_RCM_buckleDriverStatus, CH_RCM_bucklePassengerStatus, ETH_MCU_airbagTellTale, ETH_MCU_absTellTale, ETH_MCU_tractionControlTellTale, CH_EPAS3P_internalSAS, CH_EPAS3P_torsionBarTorque, PT_DIS_torqueMotor, PT_DI_torqueMotor, PT_DIS_motorRPM, PT_DI_motorRPM, CH_TSL_P_Psd_StW, CH_TSL_RND_Posn_StW, PT_DI_gear, ETH_MCU_odometer, CH_ESP_absBrakeEvent, CH_ESP_stabilityControlSts, CH_ESP_longitudinalAccel, CH_ESP_lateralAccel, PT_PM_accelPedalPressed, PT_PM_pedalPosMaxA, PT_PM_pedalPosB, PT_PM_pedalPosA, PT_DI_pedalPos, CH_DTR_Dist_Rq, CH_SpdCtrlLvr_Stat, CH_GTW_brakePressed, PT_DI_brakePedalState, CH_ESP_driverBrakeApply, CH_DAS_autoLaneChangeState, CH_EPAS_torsionBarTorque, CH_EPAS_internalSAS, PT_DI_cruiseSet, CH_DAS_leadVehDx, CH_DAS_autopilotState, CH_DAS_accState, PT_DI_cruiseState, PT_DI_vehicleSpeed, CH_RCM_crashAlgoWakeup, CH_RCM_crashSeverity, ETH_MCU_performanceMode, ETH_MCU_enableCreepTorque, PT_DI_vehicleHoldState, PT_DI_autoparkState, PT_DI_systemState, PT_BMS_brickNumVoltageMax, PT_BMS_brickVoltageMax, PT_BMS_brickVoltageMin, PT_BMS_brickNumVoltageMin, PT_BMS_moduleNumTMax, PT_BMS_moduleTMax, PT_BMS_moduleNumTMin, PT_BMS_moduleTMin, PT_BMS_packCurrent, PT_BMS_packVoltage, PT_BMS_socMin, CH_DAS_pmmSysFaultReason, CH_DAS_autopilotHandsOnState, PT_DI_aebState CH_TPMS_pressureFL, CH_TPMS_pressureFR, CH_TPMS_pressureRL, CH_TPMS_pressureRR, BDY_BCFDM_latchStatus, BDY_BCFPM_latchStatus, BDY_BCCEN_driverPresent.

It is understood that the above descriptions are for purposes of illustration and are not meant to be limiting.

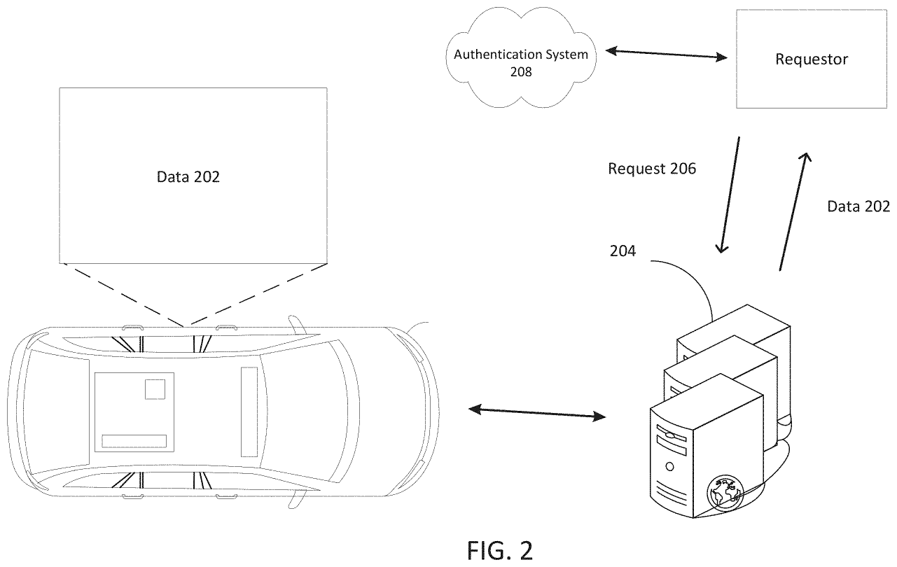

FIG. 2 depicts an illustrative diagram of a process 200 for analyzing a vehicle accident, in accordance with one or more example embodiments of the present disclosure.

Referring to FIG. 2, data 202 associated with a vehicle may be collected at the vehicle. Data 202 may include configurations of various vehicle settings and/or data associated with various sensors within the vehicle. Data 202 may include any type of data being collected by each vehicle 102, as depicted in FIG. 1.

After the data 202 is collected at the vehicle, the data 202 may be sent to vehicle data storage servers 204. In one or more embodiments, the data 202 may be automatically sent to the vehicle data storage servers 204. In other embodiments, the data 202 may be sent to the vehicle data storage servers 204 upon request by a requestor. In some embodiments, the requestor may submit a request for data 202 when the requestor has been asked to do so by various stakeholders, including, but not limited to, the vehicle's manufacturer, an insurance company, a vehicle owner, a lien holder, and/or a court. The requestor may be any system that seeks to analyze data 202 and determine how a vehicle incident occurred and how to display relevant vehicle data associated with the vehicle incident.

In one or more embodiments, when a vehicle accident has occurred, the vehicle data storage servers 204 may receive a request 206 for data 202 associated with the vehicle, or a subset of data 202 associated with the vehicle. In some embodiments, the request 206 may include at least a vehicle identifier and a time period, in order to provide sufficient specificity for obtaining relevant data.

Prior to receiving a request 206, an authentication system 208 may authenticate the requestor (e.g., via an authentication exchange). Because the vehicle data storage servers 204 are operated by the vehicle manufacturer, the vehicle manufacturer may need to know the identity of the requestor in order to ensure that only appropriate parties receive the data 202. Various processes that identify and verify the identity of the requestor may be used for the authentication system 208.

After the identity of the requestor has been verified by the vehicle authentication system 208, data 202 may be sent to the requestor. In one or more embodiments, the data 202 may be translated from a hexadecimal format (e.g., with which the data is provided from the vehicle data storage servers 204) into another format as appropriate.

In one or more embodiments, the requestor may be further collecting data from a second vehicle involved in the accident or a second vehicle that was proximate to the location of the accident at the time that the accident occurred. The data collected from a second vehicle may be similar to the data collected to the vehicle.

The requestor may then be able to create an account of the vehicle accident, including details as to how the vehicle incident occurred and how to display relevant vehicle data, from the data 202 (including the video feed) and/or additional data obtained from other vehicles. In some embodiments, the requestor may only analyze certain types of data 202 if other types of data 202 meet particular conditions. The requestor may further adopt a machine learning algorithm or cloud computing system to weight certain types of data 202 over other types of data 202. In one or more embodiments, the requestor may correlate video feed from one or more cameras of the vehicle to other data 202 that was collected at the time of the vehicle incident. The requestor may also generate a report showing the relevant data 202 for other stakeholders to peruse. The report of the vehicle accident may then be used by various stakeholders to establish fault of the parties involved in the accident.

It is understood that the above descriptions are for purposes of illustration and are not meant to be limiting.

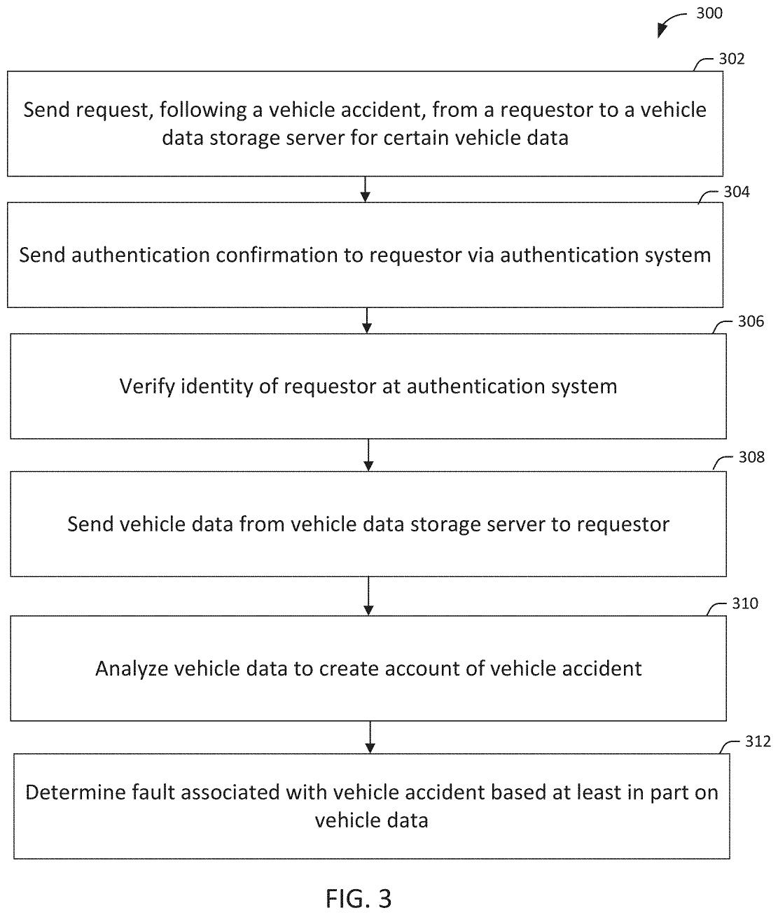

FIG. 3 depicts a flow diagram of an illustrative process for analyzing a vehicle accident, in accordance with one or more example embodiments of the present disclosure.

At block 302, an identity of a requestor may be authenticated. The authentication process may involve an authentication confirmation being sent to the requestor via an authentication system. In some embodiments, the requestor may be authenticated to one or more vehicle data storage servers prior to a request being sent to ensure that the data is being provided to an authorized party. Upon the requestor's response to the authentication confirmation, the authentication system may then verify the identity of the requestor.

At block 304, following the verification of the requestor's identity, the request from the requestor may be sent to the one or more vehicle data storage servers (e.g., for the vehicles involved in an incident, such as a vehicle accident) for certain vehicle data including video data and other vehicle data (e.g., EDR data, etc.) for use in determining relevant context of a vehicle accident. The request may be initiated by the requestor when the requestor has been asked to do so by various stakeholders, including, but not limited to, the vehicle's manufacturer, an insurance company, a vehicle owner, a lien holder, and/or a court

At block 306, vehicle data is sent from the vehicle data storage server to the requestor. The vehicle data may include video data and other data (e.g., in a hexadecimal format). For example, the vehicle data may include a vehicle identification number, a date and/or time at which the data 102 is being recorded, a version of firmware in use at the vehicle, any alerts being displayed at the vehicle, an ambient temperature of the vehicle, a state of the contactor of the vehicle, any crashes and/or collisions detected at the vehicle, whether the vehicle driver's seat belt was buckled, whether each vehicle passenger's seat belt was buckled, a status of each of the vehicle's airbags, a status of the vehicle's traction control system, a status of the vehicle's steering and suspension (SAS) system, a torque of a torsion bar of the vehicle, a torque of the vehicle's motor, a revolutions per minute (RPM) measurement of the vehicle's motor, the vehicle's odometer reading, the vehicle's brake activity, a status of the vehicle's stability control system, a longitudinal and/or lateral acceleration of the vehicle, a position of the vehicle's gas pedal, a status of whether the vehicle is engaged in an automatic lane change, a status of whether the vehicle's cruise control system is engaged, a status of whether the vehicle's autopilot system is engaged, a speed of the vehicle, a status of whether a crash detection system of the vehicle is engaged, a determination of the severity of a crash if the vehicle is involved in a collision, a status of whether the vehicle's automatic parking system is engaged, a pressure of each of the vehicle's wheels, an angle of a steering wheel, a detected lane in which the vehicle is traveling in, a direction of travel of the vehicle, video feed from various cameras at the vehicle, a presence of a driver in the vehicle, and/or any other data collected at the vehicle.

At block 308, the requestor may analyze vehicle data. The requestor may correlate video feed from one or more cameras of the vehicle to other data that was collected at the time of the vehicle incident. Other relevant data may include various vehicle settings, such as whether a particular vehicle system was engaged, the driver's actions at the time of the vehicle incident, or any other data collected by the vehicle. In one or more embodiments, the requestor may adopt a variety of rules and threshold and/or conditional values in order to determine relevance of vehicle data.

At block 310, the requestor may determine how the vehicle incident occurred based at least in part on the vehicle data and how to display relevant vehicle data associated with the vehicle incident. In one or more embodiments, the determination of how the vehicle incident occurred may include facts associated with the vehicle incident correlated to the video feed of the vehicle incident.

At block 312, a report may be generated by the requestor that may be provided to the various stakeholders. The report may be indicative of a relationship between video data obtained from the video feed and the other vehicle data. For example, the report may be used when stating an insurance claim, to complete a report made by law enforcement, for publishing in state-based crash records databases, as evidence during litigation, and/or for any other relevant purposes.

It is understood that the above descriptions are for purposes of illustration and are not meant to be limiting.

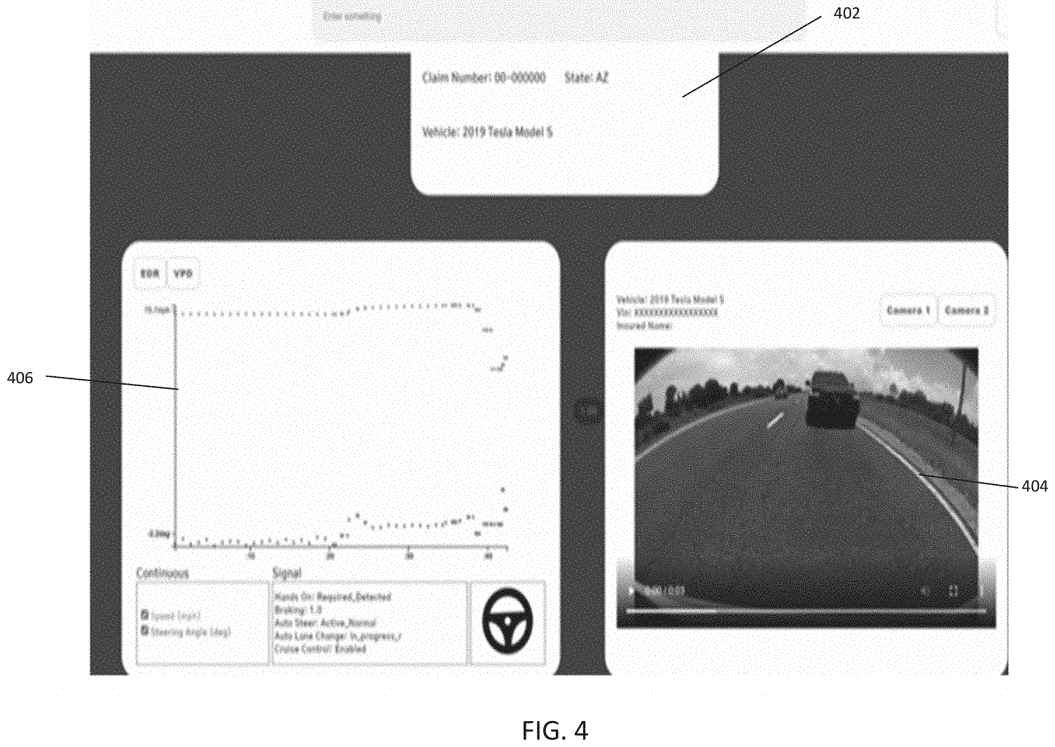

FIGS. 4-6 illustrate example screen shots from an example dashboard interface, in accordance with one or more example embodiments of the present disclosure. As depicted in FIGS. 4-6, the example dashboard interface may include both video data and sensor data collected from a vehicle.

FIG. 4 illustrates an example dashboard 400 interface. In one or more embodiments, the dashboard 400 may display background information 402 when certain video data and sensor data are being concurrently displayed. For example, the background information 402 may include a claim number, a state in which the vehicle was located at the time, a make and model of the vehicle, and other relevant information. In one or more embodiments, the dashboard 400 may display video feed 404 from a back camera of the vehicle. As depicted in FIG. 4, a blue vehicle that is behind the vehicle is recorded on the video feed 404. In one or more embodiments, the dashboard 400 may display any combination of sensor data 406 in a variety of formats. For example, as depicted in FIG. 4, a graph illustrating changes in speed and angle of steering wheel over time may displayed on the dashboard. The dashboard may also further note, in a word format, that cruise control and automatic steering are enabled, and that an automatic lane change in a rightward direction is in progress, amongst other sensor settings which may also be concurrently displayed on the dashboard 400. This configuration enables a viewer to understand the changes in sensor data as the video feed progresses.

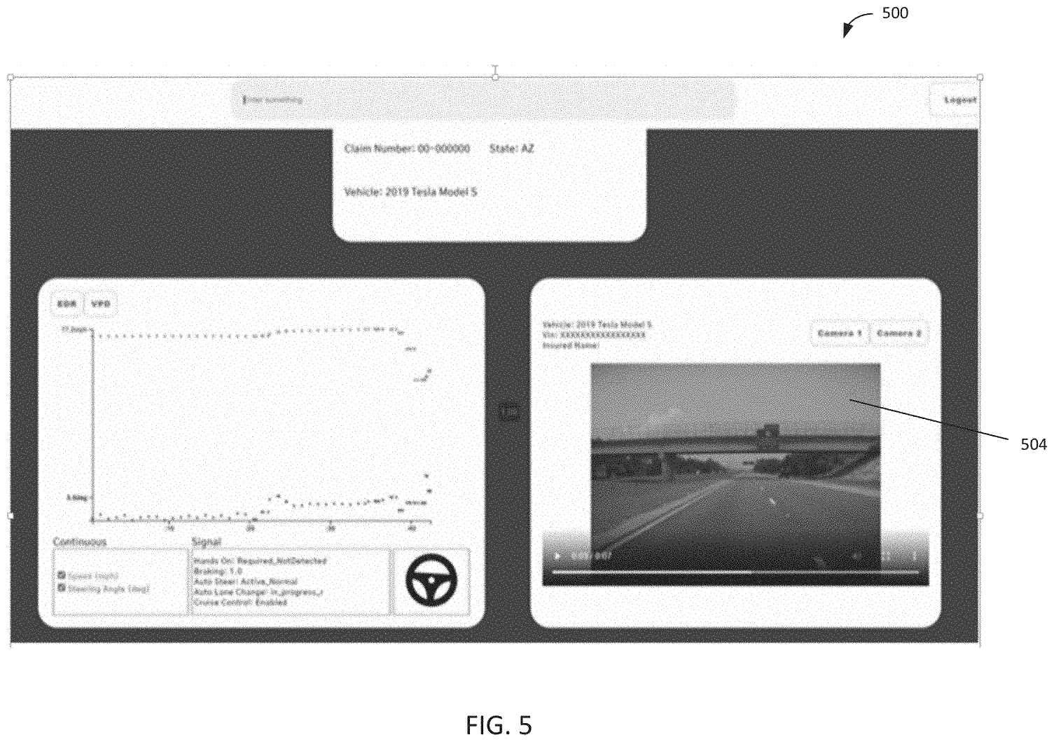

FIG. 5 illustrates an example dashboard 500. In one or more embodiments, the dashboard 500 may display similar content to the dashboard 400 illustrated in FIG. 4. In one or more embodiments, the dashboard 500 may replace or supplement video feed 404 with video feed 504 from a front camera of the vehicle, in which a second vehicle that is in front of the vehicle and in the right lane is recorded on the video feed 504.

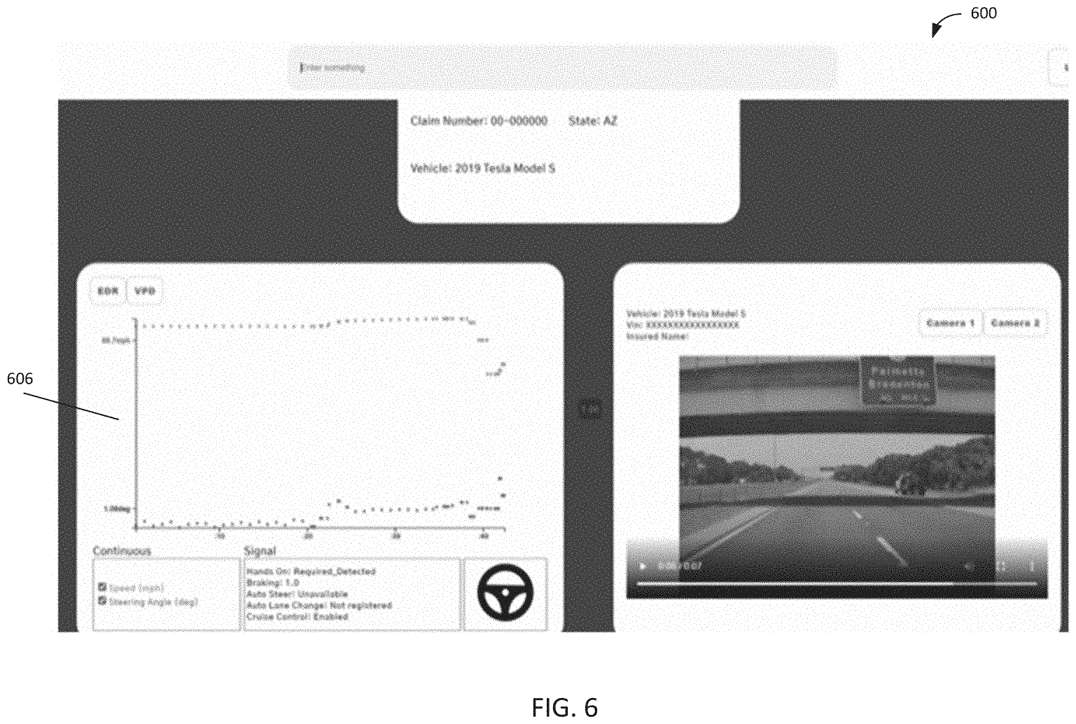

FIG. 6 illustrates an example dashboard 600. In one or more embodiments, the dashboard 600 may display similar content to the dashboard 500 illustrated in FIG. 5. In one or more embodiments, in light of video feed 504 from the front camera of the vehicle depicting the vehicle approaching behind the second vehicle, the automatic lane change may be aborted. This may be reflected in sensor data 606, which is presented on the dashboard 600. For example, sensor data 606 may now reflect that the automatic lane change is not registered.

It is understood that the above descriptions are for purposes of illustration and are not meant to be limiting.

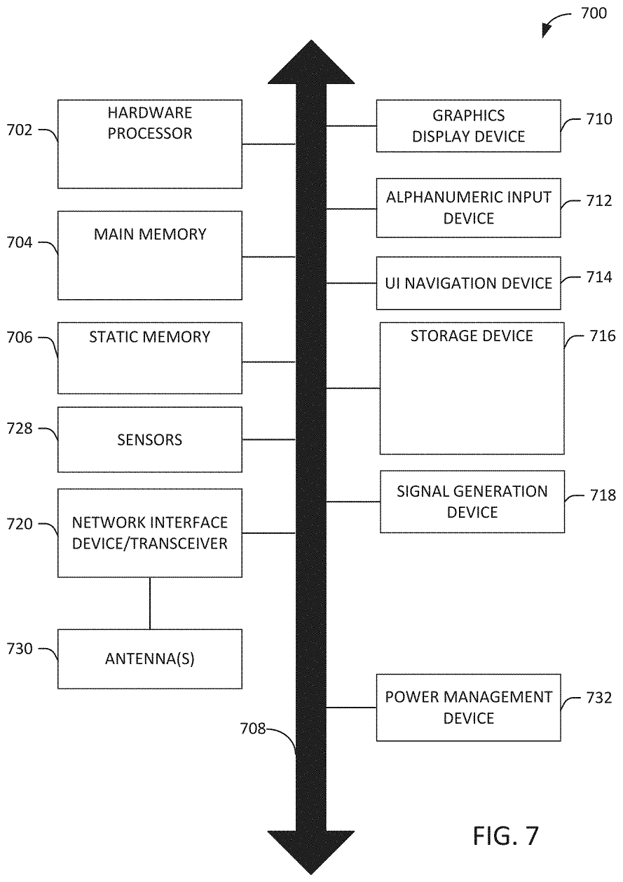

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714. In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a network interface device/transceiver 720 coupled to antenna(s) 730, and one or more sensors 728, such as a global positioning system (GPS) sensor, a compass, an accelerometer, or other sensor. The machine 700 may include an enhanced vehicle data device 719 for performing operations as described herein, for example, the process illustrated in FIG. 3. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The machine 700 may be implemented in a vehicle, vehicle data storage servers, and/or a requestor, such as the requestor depicted in FIG. 2. The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 702 for generation and processing of the baseband signals and for controlling operations of the main memory 404 and/or the storage device 716. The baseband processor may be provided on a single radio card, a single chip, or an integrated circuit (IC).

While the machine-readable medium is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine and that cause the machine to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver may include one or more physical jacks (e.g., Ethernet, coaxial, or phone jacks) or one or more antennas to connect to the communications network. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Example 1 may be a method for analyzing a vehicle incident, comprising: sending, by a first device, an authentication request to a second device associated with a vehicle data storage system; receiving, by the first device, from the second device, an authentication response; sending, by the first device, to the vehicle data storage server, a request for vehicle data of a vehicle; receiving, by the first device, based on the authentication response and the request for vehicle data, the vehicle data; determining, by the first device, a time associated with a vehicle incident associated with the vehicle; identifying, by the first device based on the time, video data of the vehicle data, the video data associated with a camera of the vehicle; identifying, by the first device, based on the time and the video data, first data of the vehicle data, the first data comprising vehicle event data recorder data of the vehicle; and generating a report indicative of a relationship between the video data and the first data at the time.

Example 2 may include the method of example 1 and/or some other example herein, wherein the request further comprises a vehicle identifier of the vehicle.

Example 3 may include the method of example 1 and/or some other example herein, transmitting the report to at least one of: an insurance company, a vehicle owner, a lien holder, or a court.

Example 4 may include the method of example 1 and/or some other example herein, wherein the first data further comprises at least one of: collision data, a speed of the vehicle, an acceleration of the vehicle, and/or a direction of the vehicle, and wherein the first data is received in hexadecimal format.

Example 5 may include the method of example 1 and/or some other example herein, wherein the video data is associated with multiple cameras of the vehicle.

Example 6 may include the method of example 5 and/or some other example herein, wherein the report further comprises a sequence of events associated with the vehicle accident and a context of the vehicle accident.

Example 7 may include the method of example 1 and/or some other example herein, wherein the vehicle is a first vehicle, and wherein the request further is for vehicle data of the first vehicle and a second vehicle.

Example 8 may include a non-transitory computer-readable medium storing computer-executable instructions which when executed by one or more processors result in performing operations comprising: sending, by a first device, an authentication request to a second device associated with a vehicle data storage system; receiving, by the first device, from the second device, an authentication response; sending, by the first device, to the vehicle data storage server, a request for vehicle data of a vehicle; receiving, by the first device, based on the authentication response and the request for vehicle data, the vehicle data; determining, by the first device, a time associated with a vehicle incident associated with the vehicle; identifying, by the first device based on the time, video data of the vehicle data, the video data associated with a camera of the vehicle; identifying, by the first device, based on the time and the video data, first data of the vehicle data, the first data comprising vehicle event data recorder data of the vehicle; and generating a report indicative of a relationship between the video data and the first data at the time.

Example 9 may include the non-transitory computer-readable medium of example 8 and/or some other example herein, wherein the request further comprises a vehicle identifier of the vehicle.

Example 10 may include the non-transitory computer-readable medium of example 8 and/or some other example herein, wherein the report is transmitted to at least one of: an insurance company, a vehicle owner, a lien holder, or a court.

Example 11 may include the non-transitory computer-readable medium of example 8 and/or some other example herein, wherein the first data further comprises at least one of: collision data, a speed of the vehicle, an acceleration of the vehicle, and/or a direction of the vehicle, and wherein the first data is received in hexadecimal format.

Example 12 may include the non-transitory computer-readable medium of example 8 and/or some other example herein, wherein the video data is associated with multiple cameras of the vehicle.

Example 13 may include the non-transitory computer-readable medium of example 8 and/or some other example herein, wherein the report further comprises a sequence of events associated with the vehicle accident and a context of the vehicle accident.

Example 14 may include an apparatus for analyzing a vehicle accident, the apparatus comprising processing circuitry coupled to storage, the processing circuitry configured to execute instructions to: send, by a first device, an authentication request to a second device associated with a vehicle data storage system; receive, by the first device, from the second device, an authentication response; send, by the first device, to the vehicle data storage server, a request for vehicle data of a vehicle; receive, by the first device, based on the authentication response and the request for vehicle data, the vehicle data; determine, by the first device, a time associated with a vehicle incident associated with the vehicle; identify, by the first device based on the time, video data of the vehicle data, the video data associated with a camera of the vehicle; identify, by the first device, based on the time and the video data, first data of the vehicle data, the first data comprising vehicle event data recorder data of the vehicle; and generate a report indicative of a relationship between the video data and the first data at the time.

Example 15 may include the device of example 14 and/or some other example herein, wherein the request further comprises a vehicle identifier of the vehicle.

Example 16 may include the device of example 14 and/or some other example herein, wherein the report is transmitted to at least one of: an insurance company, a vehicle owner, a lien holder, or a court.

Example 17 may include the device of example 14 and/or some other example herein, wherein the first data further comprises at least one of: collision data, a speed of the vehicle, an acceleration of the vehicle, and/or a direction of the vehicle, and wherein the first data is received in hexadecimal format.

Example 18 may include the device of example 14 and/or some other example herein, wherein the video data is associated with multiple cameras of the vehicle.

Example 19 may include the device of example 14 and/or some other example herein, wherein the report further comprises a sequence of events associated with the vehicle accident and a context of the vehicle accident.

Example, 20 may include the device of example 14 and/or some other example herein, wherein the vehicle is a first vehicle, and wherein the request further is for vehicle data of the first vehicle and a second vehicle.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method for analyzing a vehicle incident, comprising:
sending, by a first device, an authentication request to a second device associated with a vehicle data storage system;
receiving, by the first device, from the second device, an authentication response;
sending, by the first device, to the vehicle data storage server, a request for vehicle data of a vehicle;
receiving, by the first device, based on the authentication response and the request for vehicle data, the vehicle data;
determining, by the first device, a time associated with a vehicle incident associated with the vehicle;
identifying, by the first device based on the time, video data of the vehicle data, the video data associated with a camera of the vehicle;
identifying, by the first device, based on the time and the video data, first data of the vehicle data, the first data comprising vehicle event data recorder data of the vehicle; and
generating a report indicative of a relationship between the video data and the first data at the time.

2. The method of claim 1, wherein the request further comprises a vehicle identifier of the vehicle.

3. The method of claim 1, further comprising:
transmitting the report to at least one of: an insurance company, a vehicle owner, a lien holder, or a court.

4. The method of claim 1, wherein the first data further comprises at least one of: collision data, a speed of the vehicle, an acceleration of the vehicle, and/or a direction of the vehicle, and wherein the first data is received in hexadecimal format.

5. The method of claim 1, wherein the video data is associated with multiple cameras of the vehicle.

6. The method of claim 1, wherein the report further comprises a sequence of events associated with the vehicle accident and a context of the vehicle accident.

7. The method of claim 1, wherein the vehicle is a first vehicle, and wherein the request further is for vehicle data of the first vehicle and a second vehicle.

8. A non-transitory computer-readable medium storing computer-executable instructions which when executed by one or more processors result in performing operations comprising:
sending, by a first device, an authentication request to a second device associated with a vehicle data storage system;
receiving, by the first device, from the second device, an authentication response;
sending, by the first device, to the vehicle data storage server, a request for vehicle data of a vehicle;
receiving, by the first device, based on the authentication response and the request for vehicle data, the vehicle data;
determining, by the first device, a time associated with a vehicle incident associated with the vehicle;
identifying, by the first device based on the time, video data of the vehicle data, the video data associated with a camera of the vehicle;
identifying, by the first device, based on the time and the video data, first data of the vehicle data, the first data comprising vehicle event data recorder data of the vehicle; and
generating a report indicative of a relationship between the video data and the first data at the time.

9. The non-transitory computer-readable medium of claim 8, wherein the request further comprises a vehicle identifier of the vehicle.

10. The non-transitory computer-readable medium of claim 8, wherein the report is transmitted to at least one of: an insurance company, a vehicle owner, a lien holder, or a court.

11. The non-transitory computer-readable medium of claim 8, wherein the first data further comprises at least one of: collision data, a speed of the vehicle, an acceleration of the vehicle, and/or a direction of the vehicle, and wherein the first data is received in hexadecimal format.

12. The non-transitory computer-readable medium of claim 8, wherein the video data is associated with multiple cameras of the vehicle.

13. The non-transitory computer-readable medium of claim 8, wherein the report further comprises a sequence of events associated with the vehicle accident and a context of the vehicle accident.

14. An apparatus for analyzing a vehicle accident, the apparatus comprising processing circuitry coupled to storage, the processing circuitry configured to execute instructions to:
send, by a first device, an authentication request to a second device associated with a vehicle data storage system;
receive, by the first device, from the second device, an authentication response;
send, by the first device, to the vehicle data storage server, a request for vehicle data of a vehicle;
receive, by the first device, based on the authentication response and the request for vehicle data, the vehicle data;
determine, by the first device, a time associated with a vehicle incident associated with the vehicle;
identify, by the first device based on the time, video data of the vehicle data, the video data associated with a camera of the vehicle;
identify, by the first device, based on the time and the video data, first data of the vehicle data, the first data comprising vehicle event data recorder data of the vehicle; and
generate a report indicative of a relationship between the video data and the first data at the time.

15. The apparatus of claim 14, wherein the request further comprises a vehicle identifier of the vehicle.

16. The apparatus of claim 14, wherein the report is transmitted to at least one of: an insurance company, a vehicle owner, a lien holder, or a court.

17. The apparatus of claim 14, wherein the first data further comprises at least one of: collision data, a speed of the vehicle, an acceleration of the vehicle, and/or a direction of the vehicle, and wherein the first data is received in hexadecimal format.

18. The apparatus of claim 14, wherein the video data is associated with multiple cameras of the vehicle.

19. The apparatus of claim 14, wherein the report further comprises a sequence of events associated with the vehicle accident and a context of the vehicle accident.

20. The apparatus of claim 14, wherein the vehicle is a first vehicle, and wherein the request further is for vehicle data of the first vehicle and a second vehicle.
